(19) United States
(12) Patent Application Publication
(10) Pub. No.: US 2026/0195432 A1
(43) Pub. Date: Jul. 9, 2026

(54) MIXED REALITY BIOMETRIC AUTHENTICATION SYSTEM FOR ACCESS CONTROL

(71) Applicant: International Business Machines Corporation, Armonk, NY (US)

(72) Inventors: Subhajit Bhuiya, Bengaluru (IN); Shawn Patrick Mullen, Buda, TX (US); Sivas SRR, Bangalore (IN); Vincent Chenneveau, Chicago, IL (US)

(21) Appl. No.: 19/010,310

(22) Filed: Jan. 6, 2025

(51) Int. Cl. G06F 21/32; G06F 21/62; G06T 19/00

(52) U.S. Cl. CPC G06F 21/32; G06F 21/629; G06T 19/006

(57) ABSTRACT

Examples described herein provide systems and methods for providing mixed reality biometric authentication and privileged access management. Aspects include receiving an identity and location of a user from a mixed reality device, identifying a physical device within a field of view of the mixed reality device, and identifying one or more mixed reality overlays based on the identity and location of a user. Aspects also include transmitting the one or more mixed reality overlays to the mixed reality device and instructing the physical device to set an access control level of the physical device, where the access control level is determined based on the identity of the user.

### BACKGROUND

The disclosure generally relates to computer security, specifically to mixed reality systems for biometric authentication and privileged access management.

Mixed reality (MR), also often referred to as augmented reality, technology integrates virtual systems into the user's experience of the physical world, offering new possibilities and applications. Currently available MR systems can be used to guide users through physical environments but lack the capability to control access to physical assets. This limitation presents challenges in environments where secure access to both virtual and physical resources is necessary. Existing solutions often rely on separate authentication methods for virtual and physical access, leading to inefficiencies and potential security vulnerabilities.

### SUMMARY

According to one aspect of the present invention, a computer-implemented method for providing mixed reality biometric authentication and privileged access management. The method includes receiving an identity and location of a user from a mixed reality device, identifying a physical device within a field of view of the mixed reality device, and identifying one or more mixed reality overlays based on the identity and location of a user. The method also includes transmitting the one or more mixed reality overlays to the mixed reality device and instructing the physical device to set an access control level of the physical device, where the access control level is determined based on the identity of the user.

The above features and advantages, and other features and advantages, of the disclosure, are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a block diagram of a computing environment, according to one or more embodiments;

FIG. 2 illustrates a block diagram of a system for providing mixed reality biometric authentication and privileged access management according to one or more embodiments;

FIG. 3 illustrates a flowchart diagram of a method for providing mixed reality biometric authentication and privileged access management according to one or more embodiments;

FIG. 4 illustrates a flowchart diagram of another method for providing mixed reality biometric authentication and privileged access management according to one or more embodiments; and

FIG. 5 illustrates a flowchart diagram of a further method for providing mixed reality biometric authentication and privileged access management according to one or more embodiments.

The detailed description explains embodiments of the disclosure, together with advantages and features, by way of example with reference to the drawings.

### DETAILED DESCRIPTION

Mixed reality (MR) technology integrates virtual systems into the user's experience of the physical world, offering new possibilities and applications. Currently available MR systems can guide users through physical environments but lack the capability to control access to physical assets. This limitation presents challenges in environments where secure access to both virtual and physical resources is necessary. Existing solutions often rely on separate authentication methods for virtual and physical access, leading to inefficiencies and potential security vulnerabilities.

Current MR systems face several disadvantages, particularly in the realm of access control. The reliance on separate authentication methods for virtual and physical access can result in fragmented security protocols, increasing the risk of unauthorized access. Additionally, the lack of integration between virtual and physical access control systems can lead to operational inefficiencies, as users navigate multiple authentication processes. This fragmentation can also complicate the management of access rights, making the task difficult to ensure consistent security policies across different environments.

The present disclosure introduces a system for mixed reality biometric authentication and privileged access management, addressing the limitations of existing MR systems. This system integrates privileged access into both virtual and physical worlds, providing a unified approach to access control. By leveraging biometric authentication, the system ensures secure and continuous access to both virtual and physical resources. The integration of mixed reality overlays enhances user interaction, offering real-time guidance and feedback during the access process. This approach streamlines authentication, reduces security vulnerabilities, and improves operational efficiency by providing a cohesive access management solution.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

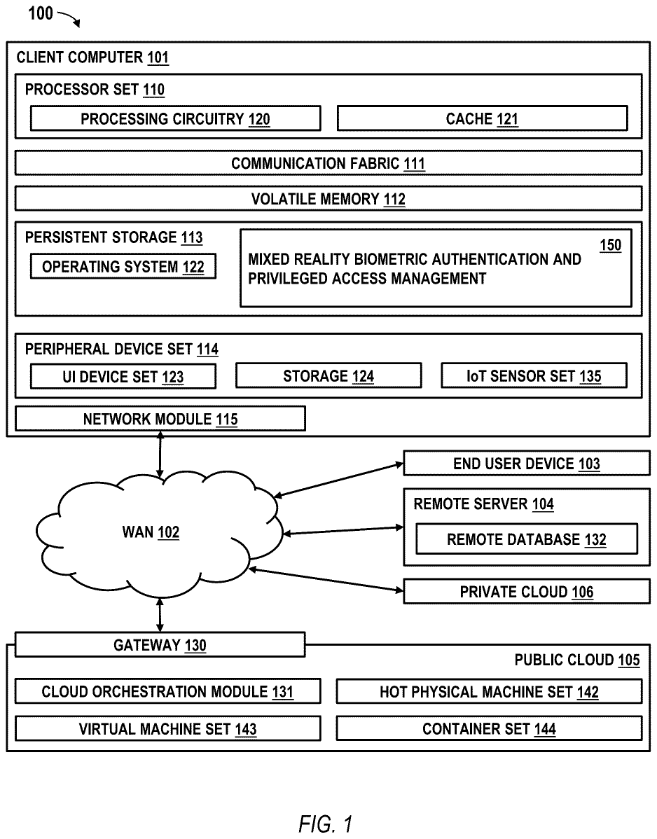

FIG. 1 illustrates a computing environment 100, according to an embodiment. Computing environment 100 contains an example of an environment for the execution of at least some of the computer code includes providing mixed reality biometric authentication and privileged access management, as shown at block 150. In addition to a controller for controlling the operations of a metal cutting tool, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122, as identified above), peripheral device set 114 (including user interface (UI) device set 123, storage 124, and Internet of Things (IoT) sensor set 135), and network module 115. Remote server 104 includes remote database 132. Public cloud 105 includes gateway 130, cloud orchestration module 131, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in persistent storage 113 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 135 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 131. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the owner of the entity is also updated).

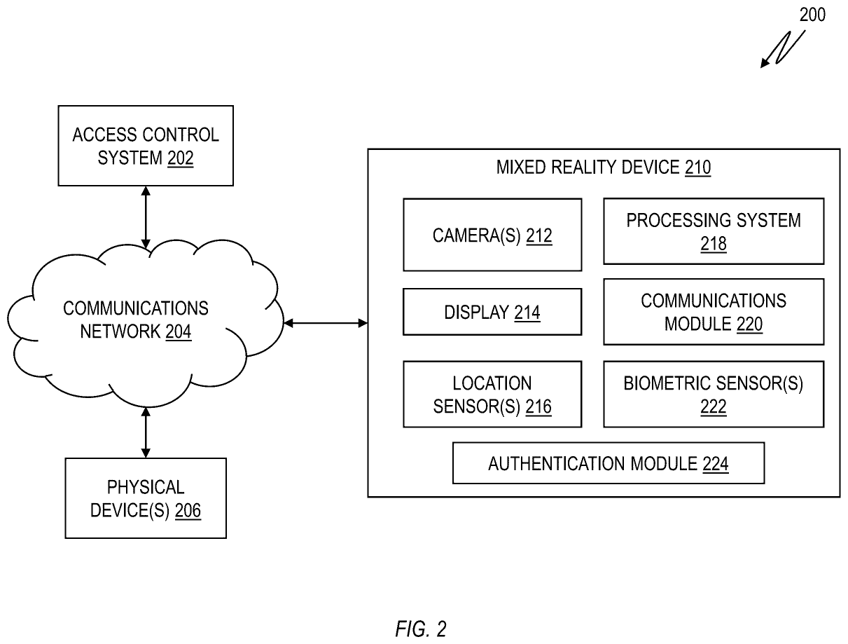

Referring now to FIG. 2, a block diagram of a system 200 for providing mixed reality biometric authentication and privileged access management is shown. The system 200 includes several components that work together to provide mixed reality biometric authentication and privileged access management. In exemplary embodiments, the system 200 includes an access control system 202, a mixed reality device 210, and one or more physical device(s) 206 that are configured communicate with one another via a communications network 204.

In exemplary embodiments, the access control system 202 serves as the central hub for managing and enforcing access policies within the mixed reality biometric authentication framework. The access control system 202 interacts with various components to ensure secure access to both virtual and physical resources. The access control system 202 processes authentication requests and coordinates with the communications network 204 to facilitate data exchange between connected devices, such as mixed reality devices 210 one or more physical device(s) 206. Implementation of the access control system 202 can involve software-based solutions running on dedicated servers or cloud-based platforms, providing scalability and flexibility in managing access control policies.

In exemplary embodiments, the communications network 204 connects the various components of the system 200, enabling seamless data transmission and communication. This network may include wired and wireless technologies, such as Ethernet, Wi-Fi, or cellular networks, to support diverse connectivity requirements. The communications network 204 ensures that data flows efficiently between the access control system 202, physical devices 206, and other components, maintaining the integrity and security of transmitted information.

In exemplary embodiments, the physical device(s) 206 represent the tangible assets that require controlled access within the mixed reality environment. These devices can include doors, safes, or other secure enclosures that the access control system 202 manages. The physical device(s) 206 interface with the access control system 202 to receive authorization signals, allowing or denying access based on the user's credentials. Integration with the mixed reality device 210 enhances the user experience by providing real-time feedback and guidance during the access process.

In one embodiment, the physical device 206 is a cabinet with glass doors, integrated into the mixed reality biometric authentication system 200. The access control system 202 manages various levels of access based on the identity of an individual, as determined by the authentication module 224 and biometric sensor(s) 222 on the mixed reality device 210. The access control system 202 can grant three distinct access levels. The first level is view-only access, where the system keeps the cabinet doors locked but activates an internal light, allowing the contents to be visible through the glass doors. This access level is suitable for users who need to verify the presence of items without physically accessing them. The second level is full access, where the system unlocks the cabinet doors and turns on the light, enabling the user to both see and physically access the contents. This level is granted to individuals with full authorization to handle the items within the cabinet. The third level is restricted access, where the system keeps the cabinet doors locked and the lights off, preventing both visual and physical access to the contents. This level is applied to individuals without the necessary authorization to view or access the items. The mixed reality device 210 provides real-time feedback and guidance to the user, displaying their current access level and any additional instructions. The communications network 204 ensures seamless data exchange between the mixed reality device 210, the access control system 202, and the cabinet, maintaining security and efficiency in access management.

In exemplary embodiments, the mixed reality device 210 functions as the primary interface for users interacting with the system 200. The mixed reality device 210 integrates virtual elements into the user's physical environment, offering an augmented reality experience. Equipped with camera(s) 212, display 214, location sensor(s) 216, and biometric sensor(s) 222, the mixed reality device 210 captures and processes user data to facilitate authentication and access control. The device communicates with the access control system 202 and other components via the communications module 220, ensuring continuous connectivity and data exchange.

In exemplary embodiments, the camera(s) 212 on the mixed reality device 210 capture visual data from the user's environment, supporting both authentication and augmented reality functionalities. These cameras may employ advanced imaging technologies, such as infrared or depth sensing, to enhance accuracy and reliability. The captured data assists in verifying user identity and providing contextual information for the augmented reality display.

In exemplary embodiments, the display 214 presents virtual elements overlaid on the user's physical environment, offering an intuitive interface for interacting with the system 200. This display 214 can be disposed in a head-mounted device, such as smart glasses, or a handheld device, like a tablet. In exemplary embodiments, the display 214 provides visual feedback during the authentication process and guides users through secure areas, enhancing the overall user experience.

In exemplary embodiments, the location sensor(s) 216 determine the user's position within the physical environment, enabling context-aware interactions with the system 200. These sensors may include GPS, accelerometers, or other positioning technologies to provide accurate location data. In one embodiment, an indoor positioning system can be implemented using a combination of technologies to accurately determine a user's position within a physical environment. The indoor positioning system may utilize location sensor(s) 216, which can include GPS, Wi-Fi, Bluetooth, and RFID technologies. For instance, Wi-Fi or Bluetooth beacons can be strategically placed throughout the area, emitting signals that the user's device can detect. By analyzing the strength and timing of these signals, the system can calculate the user's precise location. Additionally, accelerometers and gyroscopes within the device can provide movement data, enhancing the accuracy of the positioning system by tracking the user's motion and orientation. In exemplary embodiments, the location sensor(s) 216 work in conjunction with the access control system 202 to ensure that users access only authorized areas.

In exemplary embodiments, the processing system 218 within the mixed reality device 210 handles data processing and computational tasks necessary for authentication and augmented reality functionalities. The processing system 218 system may include a combination of CPUs, GPUs, and specialized hardware accelerators to efficiently manage complex operations. The processing system 218 executes algorithms for biometric recognition, data analysis, and virtual content rendering, ensuring smooth and responsive user interactions.

In exemplary embodiments, the communications module 220 facilitates data exchange between the mixed reality device 210 and other components of the system 200. The communications module 220 supports various communication protocols, such as Bluetooth, Wi-Fi, or NFC, to ensure reliable connectivity. The communications module 220 enables real-time data transmission, allowing the mixed reality device 210 to interact seamlessly with the access control system 202 and other networked devices.

In exemplary embodiments, the biometric sensor(s) 222 on the mixed reality device 210 capture biometric data, such as retinal scans or fingerprints, for user authentication. These sensors employ advanced technologies to ensure high accuracy and security in verifying user identity. The biometric sensor(s) 222 provide continuous authentication, allowing users to maintain access without repeated manual input.

For example, in an embodiment where fingerprint scanning is used, the mixed reality device 210 can detect the removal of the finger from the scanner to trigger re-authentication. This ensures that the user remains authenticated only while actively interacting with the device. The frequency of verification can be adjusted based on security requirements, such as verifying identity every few seconds or upon detecting significant movement. In another embodiment, retinal scans can be performed periodically or continuously, depending on the device's capabilities and the security level required. Continuous authentication allows the system to maintain a secure session without interrupting the user, providing a seamless experience while ensuring that only authorized individuals have access.

In exemplary embodiments, the authentication module 224 processes biometric data and other user credentials to determine access rights within the system 200. The authentication module 224 module interfaces with the access control system 202 to validate user identity and authorize access to secure resources. The authentication module 224 employs sophisticated algorithms and security protocols to ensure robust and reliable authentication, safeguarding both virtual and physical assets.

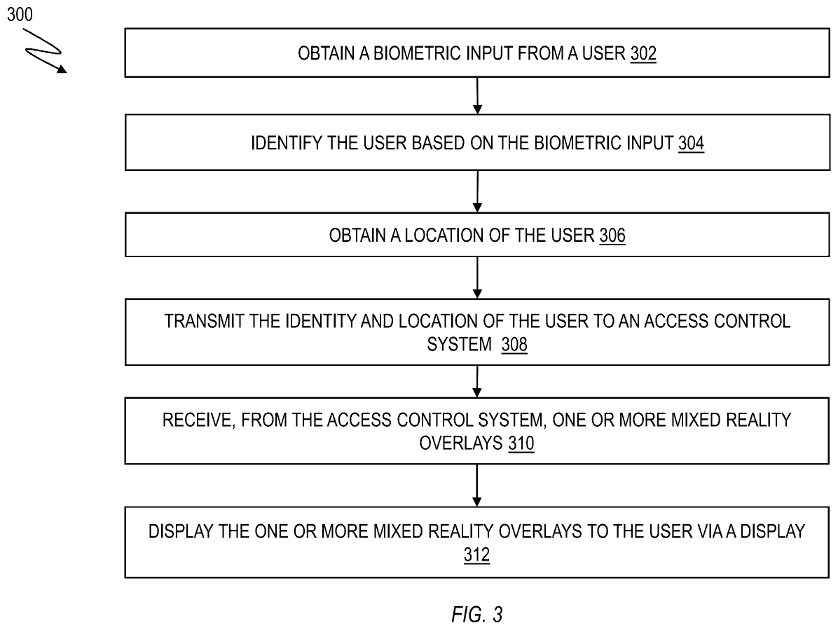

Referring now to FIG. 3, a flowchart diagram of a method 300 for providing mixed reality biometric authentication and privileged access management is shown. In exemplary embodiments, the method 300 is performed by the mixed reality device 210 of system 200 shown in FIG. 2. The method 300 begins at block 302 by obtaining a biometric input from a user. The mixed reality device 210 captures this input using biometric sensor(s) 222, which may include technologies such as retinal scanners or fingerprint readers. In exemplary embodiments, the biometric input serves as the initial step in authenticating the user within the system 200. The processing system 218 processes the captured biometric data to ensure accuracy and reliability. The authentication module 224 then analyzes the biometric input to verify the user's identity, facilitating secure access to both virtual and physical resources.

Once the mixed reality device 210 identifies the user based on the biometric input, the method includes identifying the user, as shown at block 304. In exemplary embodiments, the authentication module 224 is configured to determine the user's identity. This process involves comparing the captured biometric data against stored credentials within the access control system 202. The identification step ensures that only authorized users gain access to privileged areas and resources. In exemplary embodiments, the processing system 218 executes sophisticated algorithms to match the biometric input with existing records, maintaining high security standards.

Next, as shown at block 306, the method 300 includes obtaining the location of the user. In exemplary embodiments, the mixed reality device 210 obtains a location of the user by using one or more location sensor(s) 216 within the mixed reality device 210 to determine the user's position in the physical environment. These sensors 216 may utilize GPS, Wi-Fi, or Bluetooth technologies to provide precise location data. The location information enables context-aware interactions, allowing the system to tailor access permissions based on the user's physical position.

Next, as shown at block 308, the method 300 includes transmitting the identity and location of the user to the access control system 202. In exemplary embodiments, the communications module 220 facilitates this data exchange, ensuring that the access control system 202 receives accurate and timely information. The access control system 202 uses the transmitted data to evaluate the user's access rights, coordinating with physical device(s) 206 to enforce appropriate access levels. This step ensures that the system maintains a secure and efficient access management process.

Next, as shown at block 310, the method 300 includes receiving, from the Access control system, one or more mixed reality overlays. In exemplary embodiments, the access control system 202 is configured to transmit one or more mixed reality overlays to the mixed reality device in response to receiving the identity and location data. These overlays provide visual cues and guidance to the user, enhancing the augmented reality experience.

The method 300 concludes at block 312 by displaying the one or more mixed reality overlays to the user via a display 214. In exemplary embodiments, the one or more mixed reality overlays may include information about access permissions, navigation assistance, or alerts regarding restricted areas. In exemplary embodiments, the processing system 218 ensures that the overlays are rendered smoothly and accurately, providing a seamless user experience. In exemplary embodiments, the display 214 integrates one or more mixed reality overlays into the user's physical environment, offering an intuitive interface for interacting with physical devices 206 in the system 200. The one or more mixed reality overlays may guide the user through secure areas and provide real-time feedback on access levels and permissions. In exemplary embodiments, the mixed reality device 210 continuously updates the display based on the user's movements and interactions, ensuring that the user remains informed and secure throughout the process.

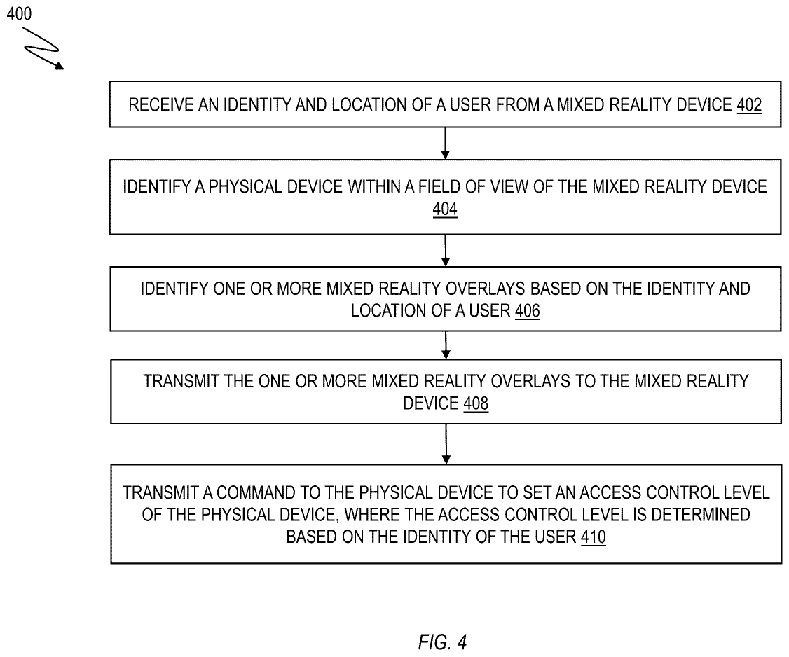

Referring now to FIG. 4, a flowchart diagram of a method 400 for providing mixed reality biometric authentication and privileged access management is shown. In exemplary embodiments, the method 400 is performed by the access control system 202 shown in FIG. 2. The method 400 begins at block 402 by receiving an identity and location of a user from a mixed reality device. In exemplary embodiments, the access control system 202 initiates the method 400 by receiving data transmitted from the mixed reality device 210. The communications module 220 within the mixed reality device 210 facilitates this data exchange, ensuring accurate and timely transmission. In exemplary embodiments, the identity and location data are used to determine the user's access rights of the user and to customize the mixed reality experience to the user's current context.

Next, as shown at block 404, the method 400 includes identifying a physical device within a field of view of the mixed reality device. In exemplary embodiments, the mixed reality device 210, equipped with camera(s) 212 and location sensor(s) 216, captures visual and positional data to identify physical devices in proximity to the mixed reality device. In exemplary embodiments, the access control system 202 can identify a physical device within the field of view of the mixed reality device by utilizing the user's location data and a detailed map of the environment. This map includes the positions of physical devices and other users in the vicinity. When the mixed reality device 210 captures the user's location using location sensor(s) 216, this data is transmitted to the access control system 202. The access control system 202 cross-references the user's location with the map to determine which physical devices are nearby. By analyzing the spatial relationship between the user's position and the mapped devices, the system can accurately identify which devices fall within the user's field of view. Additionally, the system considers the presence of other users to ensure that access permissions are managed appropriately, avoiding conflicts or unauthorized access. This process allows the access control system 202 to provide relevant mixed reality overlays and access instructions to the user, enhancing the interaction with the physical environment while maintaining security and efficiency.

In various embodiments, the system for identifying a physical device within the field of view of a mixed reality device can be adapted to utilize different technologies and configurations to enhance the functionality and adaptability of the system. One embodiment involves the use of RFID tags embedded within physical devices, which are detected by an RFID reader integrated into the mixed reality device. This setup allows for seamless identification of devices in environments where RFID technology is prevalent, such as warehouses or retail spaces. Another embodiment could utilize QR codes disposed on the physical devices to identify the physical devices. Another embodiment could incorporate advanced imaging technologies, such as infrared or depth-sensing cameras, to visually identify devices based on their shape, size, or other distinguishing features. This approach is particularly useful in settings where visual identification is more practical or where RFID infrastructure is not available. Additionally, the system can be configured to work with various communication protocols, such as Bluetooth or Wi-Fi, to facilitate data exchange between the mixed reality device and the physical devices, ensuring reliable connectivity and real-time updates. These embodiments demonstrate the system's flexibility in adapting to different operational environments and technological infrastructures, while maintaining the primary functionality of identifying physical devices within the mixed reality framework.

Next, as shown at block 406, the method 400 includes identifying one or more mixed reality overlays based on the identity, authorization access rights, and location of a user. In exemplary embodiments, the access control system 202 processes the received identity and location data to determine appropriate overlays. These overlays provide visual cues and guidance, enhancing the user's interaction with the physical environment. The overlays may include information about access permissions, navigation assistance, or alerts regarding restricted areas, tailored to the user's current context and access rights. Access may also include displaying sensitive data, such as instructions with chemical compounds for the task at hand.

In a mixed reality environment, overlays can provide detailed visual cues and instructions to enhance user interaction with physical devices. For example, when a user needs to repair a physical device, such as a server, the overlay can display step-by-step instructions directly in the user's field of view. These instructions might include visual markers highlighting specific components to be checked or replaced, animations demonstrating the correct procedure for disassembly and reassembly, and safety warnings to ensure proper handling.

For navigation within a large data center, overlays can offer real-time directions to locate a specific server. The system can project a virtual path on the floor, guiding the user through the aisles. Additionally, the overlay can provide information about the server's status, such as its operational condition or maintenance history, once the user arrives at the destination. This context-aware guidance ensures efficient navigation and task execution, enhancing both productivity and security within the environment.

In various embodiments, the system for customizing mixed reality overlays based on user access levels can be implemented in diverse environments to enhance user interaction and security. One embodiment involves a healthcare setting where the mixed reality device provides overlays that guide staff through restricted areas, displaying access permissions for viewing patient records or accessing medication storage. The overlays can dynamically update to reflect changes in access levels, such as when a staff member's role changes or when new security protocols are implemented. In another embodiment, within a corporate environment, the system can offer overlays that assist employees in navigating secure office spaces, highlighting areas they are authorized to enter and providing real-time updates on access permissions during meetings or collaborative projects. Additionally, in a manufacturing setting, the overlays can guide technicians through complex machinery layouts, indicating which equipment they are authorized to operate or maintain, and updating in real-time as they move through the facility. These embodiments demonstrate the system's adaptability in providing context-aware guidance and security across various operational environments, ensuring that users receive relevant and timely information tailored to their access rights.

As shown at block 408, the method 400 includes transmitting the one or more mixed reality overlays to the mixed reality device. In exemplary embodiments, the access control system 202 sends the overlays to the mixed reality device 210 via the communications network 204. The communications module 220 ensures reliable and efficient data transmission, allowing the mixed reality device 210 to render the overlays accurately. This step ensures that the user receives real-time feedback and guidance, enhancing the augmented reality experience.

The method 400 concludes at block 410 by transmitting a command to the physical device to set an access control level of the physical device, where the access control level is determined based on the identity of the user. In exemplary embodiments, the access control system 202 evaluates the user's credentials and determines the appropriate access level for the identified physical device. The access control system 202 then sends a command to the physical device(s) 206 to enforce the determined access level, allowing or denying access based on the user's authorization. This process ensures secure and efficient management of access to both virtual and physical resources within the mixed reality environment.

In one example, a user equipped with a mixed reality device 210 approaches a door to a secure data room. As the user nears the door, the location sensor(s) 216 within the device determine the user's proximity and the biometric sensor(s) 222 verify the user's identity, ensuring they have the necessary authorization to access the room. The access control system 202, connected to the mixed reality device 210 via the communications network 204, receives the user's identity and location data. The access control system 202, cross-references this information with its access policies and determines that the user is authorized to enter the secure data room. As a results, as the user comes within a few feet of the door, the access control system 202, automatically sends a command to unlock the door. Throughout this process, the mixed reality device 210 provides real-time feedback to the user. Initially, a mixed reality overlay displayed on the device's display 214 shows an indication that the door is locked. As the user approaches the door and their identity is confirmed, the overlay updates to shows an indication that the door is now unlocked, allowing the user to enter. This seamless interaction enhances security while providing a smooth user experience.

In one embodiment, the system utilizes a mixed reality device equipped with advanced biometric sensors, such as retinal scanners or fingerprint readers, to authenticate users and determine their access rights. Upon successful authentication, the system communicates with a physical device, such as a secure door or cabinet, to unlock the physical device if the user is authorized. This unlocking mechanism can be implemented using various technologies, such as electronic locks controlled via Bluetooth or Wi-Fi, ensuring seamless integration with existing security infrastructure. In another embodiment, the system employs RFID technology, where the mixed reality device reads RFID tags embedded in the physical device to verify the physical device's identity before unlocking. This approach is particularly useful in environments where RFID is prevalent, such as warehouses or retail spaces. Additionally, the system can dynamically adjust access permissions based on real-time environmental changes, such as user location or role updates, providing a flexible and responsive security solution. These embodiments demonstrate the system's adaptability across different operational settings, ensuring secure and efficient access management.

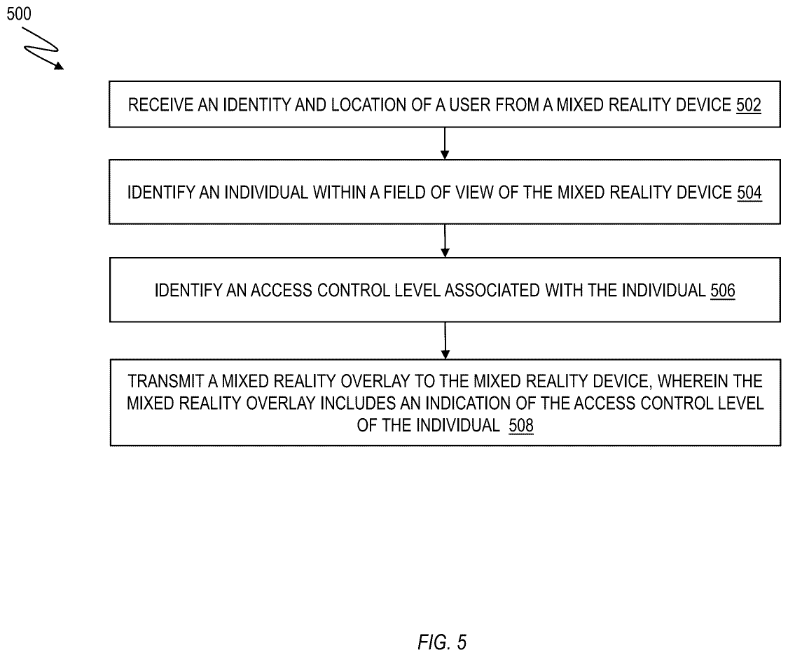

Referring now to FIG. 5, a flowchart diagram of a method 500 for providing mixed reality biometric authentication and privileged access management is shown. In exemplary embodiments, the method 500 is performed by the access control system shown in FIG. 2. The method 500 begins at block 502 by receiving an identity and location of a user from a mixed reality device. In exemplary embodiments, a mixed reality device 210 captures the user's identity through biometric sensor(s) 222, such as retinal scanners or fingerprint readers, and determines the user's location using location sensor(s) 216.

Next, as shown at block 406, the method 400 includes identifying an individual within the field of view of the mixed reality device. In exemplary embodiments, the mixed reality device 210, equipped with camera(s) 212, captures visual data that can be used to identify individuals in proximity and transmits the captured visual data to the access control system. In exemplary embodiments, the access control system 202 can identify an individual within the field of view of the mixed reality device by utilizing facial recognition and location data. The access control system 202 is configured to analyze visual data to perform facial recognition of known users by comparing captured facial features with a database of authorized users to verify identity. Additionally, the access control system 202 can use location data from other mixed reality devices to enhance identification. Each device transmits its user's identity and location to the access control system 202 via the communications network 204. By cross-referencing this location data with the user's position, the access control system 202 can accurately identify individuals in proximity, even if they are not directly visible to the camera. In exemplary embodiments, both of these identification methods may be used to provide robust identification, allowing the access control system 202 to manage access permissions effectively and maintain security within the environment.

Following the identification of an individual within a field of view of the mixed reality device, the method 500 includes identifying an access control level associated with the individual, as shown at block 506. In exemplary embodiments, the access control system 202 processes the received identity data to determine the user's access rights. This involves cross-referencing the user's credentials with predefined access policies stored within the system. The access control system 202 evaluates the user's authorization level, ensuring that access permissions align with the user's role and responsibilities.

Next, as shown at block 508, the method 500 involves transmitting a mixed reality overlay to the mixed reality device. In exemplary embodiments, the access control system 202 generates one or more mixed reality overlays based on the user's identity and access level. These overlays provide visual cues and guidance, enhancing the user's interaction with the physical environment. The communications module 220 ensures reliable transmission of the overlays to the mixed reality device 210, allowing the user to receive real-time feedback and instructions.

In exemplary embodiments, the mixed reality overlay includes an indication of the access control level of the individual. The display 214 on the mixed reality device 210 presents this overlay, integrating virtual elements into the user's physical environment. The overlay may include information about access permissions, navigation assistance, or alerts regarding restricted areas. The processing system 218 ensures smooth rendering of the overlay, providing an intuitive interface for the user to interact with the system 200.

In exemplary embodiments, by displaying an indication of the access control level of the individual via a mixed reality overlay the user can easily identify the access control level of the user. As a result, users can confidently know which nearby individual they can discuss various sensitive subject matter with. For instance, in a corporate setting, a user wearing a mixed reality device can see overlays indicating the access levels of colleagues nearby. If a colleague has a high-level clearance, the user knows they can discuss confidential project details with them. Conversely, if another colleague has a lower clearance, the user can avoid discussing sensitive information. In another example, within a healthcare environment, a doctor can use the mixed reality overlay to identify which medical staff members have the necessary clearance to discuss patient information. This ensures compliance with privacy regulations and enhances communication efficiency.

In various embodiments, the system for dynamically updating mixed reality overlays based on real-time environmental changes can be implemented across diverse settings to enhance user interaction and security. In a healthcare environment, the system can adjust overlays to reflect changes in patient status or room access permissions, ensuring that medical staff receive up-to-date information as they move through the facility. For instance, if a patient's condition changes, the overlay can update to alert staff of new protocols or restricted access to certain areas. In a corporate setting, the system can modify overlays during meetings or collaborative projects, providing real-time updates on access permissions and highlighting authorized areas for discussion. This ensures that sensitive information is only shared with individuals who have the appropriate clearance. In a manufacturing environment, the system can adapt overlays to guide technicians through machinery layouts, indicating which equipment they are authorized to operate or maintain. As technicians move through the facility, the overlays can update to reflect changes in operational status or safety protocols, enhancing both productivity and safety. These embodiments demonstrate the system's adaptability in providing context-aware guidance and security across various operational environments, ensuring that users receive relevant and timely information tailored to their access rights.

In one example, a Mixed Reality Unified Security (MRUS) system can be used to provide a real-time persistent chain of custody and continuous clearance while an engineer conducts a fix to a highly sensitive piece of hardware, such as voting machines. An example of such a use is described in detail below.

Upon arrival at the secure facility, an engineer tasked with repairing a malfunctioning voting machine, uses a mixed reality device equipped with biometric sensors to authenticate his identity. The mixed reality performs a retinal scan to verify the engineer's credentials, and the MRUS system cross-references the biometric data with its database to confirm the engineer's authorization to access the facility and the voting machine. Once authenticated, the MRUS system grants the engineer access to the secure area where the voting machine is located. The mixed reality device provides real-time navigation assistance, guiding the engineer through the facility to the specific location of the voting machine. The mixed reality device displays mixed reality overlays indicating authorized paths and restricted areas, ensuring the engineer does not inadvertently enter unauthorized zones.

As the engineer approaches the voting machine, the MRUS system continuously monitors his location and biometric data to maintain a persistent chain of custody. The mixed reality device periodically re-authenticates the engineer using biometric sensors to ensure that the authorized individual remains present throughout the repair process. This continuous clearance monitoring prevents unauthorized access and ensures that only the engineer can interact with the voting machine. The MRUS system maintains a real-time log of the engineer's activities, documenting each step of the repair process. This log includes timestamps, location data, and biometric authentication records, creating a comprehensive chain of custody for the voting machine. The mixed reality device captures visual data of the repair process, providing additional evidence of the engineer actions and ensuring transparency.

During the repair, the mixed reality device displays step-by-step instructions and visual cues overlaid on the voting machine. These mixed reality overlays guide the engineer through the repair process, highlighting specific components to be checked or replaced. The device also provides safety warnings and operational guidelines to ensure proper handling of the sensitive hardware. Upon completing the repair, the engineer uses the mixed reality device to perform a final biometric authentication, confirming that the authorized individual has completed the task. The MRUS system updates the chain of custody log with the completion timestamp and final authentication record. The system also verifies that the voting machine is functioning correctly and that all security protocols have been followed.

The MRUS system generates a detailed report of the repair process, including the chain of custody log, biometric authentication records, location data, and visual documentation. This report is securely stored and can be accessed by authorized personnel for auditing and compliance purposes. The comprehensive documentation ensures accountability and provides a clear record of the repair process for future reference. This use case demonstrates how the MRUS system provides a secure and efficient workflow for repairing highly sensitive hardware, such as voting machines. By integrating biometric authentication, real-time location tracking, and mixed reality overlays, the system ensures continuous clearance monitoring, maintains a persistent chain of custody, and provides guided instructions for the repair process. This approach enhances security, transparency, and accountability, ensuring that only authorized personnel can access and interact with sensitive hardware.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method for providing mixed reality biometric authentication and privileged access management, the method comprising:
receiving an identity and location of a user from a mixed reality device;
identifying a physical device within a field of view of the mixed reality device;
identifying one or more mixed reality overlays based on the identity and location of a user;
transmitting the one or more mixed reality overlays to the mixed reality device; and
instructing the physical device to set an access control level of the physical device, wherein the access control level is determined based on the identity of the user.

2. The method of claim 1, wherein the identity of the user is determined based on data received from using biometric sensors disposed in the mixed reality device.

3. The method of claim 1, wherein the location of the user is determined based on position sensors disposed in the mixed reality device.

4. The method of claim 1, wherein the physical device is identified based on one or more of an RFID tag or QR code disposed on the physical device.

5. The method of claim 1, wherein identifying one or more mixed reality overlays comprises customizing the one or more mixed reality overlays based on user access levels.

6. The method of claim 5, further comprising dynamically updating the overlays based on real-time environmental changes.

7. The method of claim 1, wherein the one or more mixed reality overlays comprises an indication of the access control level of an individual within the field of view of the mixed reality device.

8. The method of claim 1, wherein instructing the physical device to set the access control level of the physical device includes instructing a physical device policy enforcement point to grant access to the physical device based on a determination that user is authorized to access the physical device.

9. A system comprising:
a memory comprising computer readable instructions; and
a processing device for executing the computer readable instructions, the computer readable instructions controlling the processing device to perform operations comprising:
receiving an identity and location of a user from a mixed reality device;
identifying a physical device within a field of view of the mixed reality device;
identifying one or more mixed reality overlays based on the identity and location of a user;
transmitting the one or more mixed reality overlays to the mixed reality device; and
instructing the physical device to set an access control level of the physical device, wherein the access control level is determined based on the identity of the user.

10. The system of claim 9, wherein the identity of the user is determined based on data received from using biometric sensors disposed in the mixed reality device.

11. The system of claim 9, wherein the location of the user is determined based on position sensors disposed in the mixed reality device.

12. The system of claim 9, wherein the physical device is identified based on one or more of an RFID tag or QR code disposed on the physical device.

13. The system of claim 9, wherein identifying one or more mixed reality overlays comprises customizing the one or more mixed reality overlays based on user access levels.

14. The system of claim 13, wherein the operations further comprise dynamically updating the overlays based on real-time environmental changes.

15. The system of claim 9, wherein the one or more mixed reality overlays comprises an indication of the access control level of an individual within the field of view of the mixed reality device.

16. The system of claim 9, wherein instructing the physical device to set the access control level of the physical device includes instructing a physical device policy enforcement point to grant access to the physical device based on a determination that user is authorized to access the physical device.

17. A computer program product for providing mixed reality biometric authentication and privileged access management, the computer program product comprising:
a set of one or more computer-readable storage media;
program instructions, collectively stored in the set of one or more storage media, for causing a processor set to perform the following computer operations:
receiving an identity and location of a user from a mixed reality device;
identifying a physical device within a field of view of the mixed reality device;
identifying one or more mixed reality overlays based on the identity and location of a user;
transmitting the one or more mixed reality overlays to the mixed reality device; and
instructing the physical device to set an access control level of the physical device, wherein the access control level is determined based on the identity of the user.

18. The computer program product of claim 17, wherein the identity of the user is determined based on data received from using biometric sensors disposed in the mixed reality device.

19. The computer program product of claim 17, wherein the location of the user is determined based on position sensors disposed in the mixed reality device.

20. The computer program product of claim 17, wherein instructing the physical device to set the access control level of the physical device includes instructing a physical device policy enforcement point to grant access to the physical device based on a determination that user is authorized to access the physical device.
